(19) United States
(12) Patent Application Publication
(10) Pub. No.: US 2026/0302007 A1
(43) Pub. Date: Oct. 1, 2026

(54) VOLTAGE NON-LINEAR RESISTOR CERAMIC AND ELECTRONIC DEVICE

(71) Applicant: TDK CORPORATION, Tokyo (JP)

(72) Inventors: Tomohisa AZUMA, Tokyo (JP); Hidenobu UMEDA, Tokyo (JP); Kazuhiko ITOH, Tokyo (JP); Masayuki UCHIDA, Tokyo (JP); Mizuho CHIBA, Tokyo (JP); Kazuki FUKASAWA, Tokyo (JP)

(73) Assignee: TDK CORPORATION, Tokyo (JP)

(21) Appl. No.: 19/632,578

(22) Filed: Mar. 30, 2026

(30) Foreign Application Priority Data
Mar. 31, 2025 (JP) 2025-058573

(51) Int. Cl. H01C 7/112; C04B 35/457; H01C 7/102

(52) U.S. Cl. CPC H01C 7/112; C04B 35/457; H01C 7/102

(57) ABSTRACT

A voltage non-linear resistor ceramic, including: main phase grains having zinc oxide as a main component, wherein at least one of the main phase grains comprise an intragranular segregation phase, and the intragranular segregation phase includes an oxide including Sn.

### TECHNICAL FIELD

The present disclosure relates to a voltage non-linear resistor ceramic which is used, for example, for varistors, and also relates to an electronic device.

### BACKGROUND

Varistors are used for household appliances and automotive components. Electronic devices such as varistors are demanded to stably operate even when these are used under various conditions.

Patent document 1 shown in below proposes a voltage non-linear resistor with low property change even after absorbing impulse wave such as impulse surge.

This Patent Document 1 proposes to have a predetermined occupancy rate of segregation phases occupying around a ZnO particle to a predetermined rate.

### PRIOR ART DOCUMENT

### Patent Document

[Patent Document 1] JP Patent Application No. H10-270212A

### SUMMARY

One example of the object of the present disclosure is provide a voltage non-linear resistor ceramic and an electronic device having a small rate of change of capacitance after high temperature load and having an excellent ESD resistance after high temperature load.

The present inventors have carried out a keen study regarding a voltage non-linear resistor ceramic containing a main phase grain having zinc oxide as a main component. As a result, the present inventors have found that instead of having a segregation phase around the main phase grain, by having the segregation phase inside the main phase grain, it is possible to obtain the voltage non-linear resistor ceramic having a small rate of change of capacitance and an excellent ESD resistance after high temperature load.

That is, a voltage non-linear resistor ceramic according to one aspect of the present disclosure, includes:
main phase grains having zinc oxide as a main component,
wherein at least one of the main phase grains include an intragranular segregation phase, and the intragranular segregation phase includes an oxide including Sn.

The intragranular segregation phase includes zinc oxide and tin oxide; and in the intragranular segregation phase, a weight ratio of tin oxide with respect to zinc oxide in terms of ZnO and SnO₂ may preferably be 0.9 or greater to 3.1 or less, may be 1.0 or greater to 3.0 or less, may be 1.2 or greater to 2.9 or less, or may be 1.3 or greater to 2.6 or less. When the weight ratio of tin oxide with respect to zinc oxide is within such range, an excellent ESD resistance after high temperature load is achieved and a rate of change of capacitance becomes even smaller.

A ratio of a cross-section area of the intragranular segregation phase with respect to a cross-section area of the main phase grain including the intragranular segregation phase may preferably be 0.07% or greater to 18% or less, may be 0.07% or greater to 17% or less, may be 0.09% or greater to 16% or less, or 0.1% or greater to 15% or less. When the weight ratio of tin oxide with respect to zinc oxide is within such range, an excellent ESD resistance after high temperature load is achieved and a rate of change of capacitance becomes even smaller.

A ratio of a shortest distance between an outer circumference of the cross section of the main phase grain and the outer circumference of the cross section of the intragranular segregation phase with respect to a grain size of the cross section of the main phase grain including the intragranular segregation phase may preferably be 3.0% or greater to 49% or less, or 3.0% or greater to 28% or less. When said ratio is within such range, an excellent ESD resistance after high temperature load is achieved and a rate of change of capacitance becomes even smaller.

The intragranular segregation phase may include one or more selected from the group consisting of cobalt oxide, chromium oxide, silicon oxide, silver oxide, bismuth oxide, and praseodymium oxide. By configuring as such, the rate of change of capacitance after high temperature load can be maintained low and the ESD resistance after high temperature load can be further improved.

The intragranular segregation phase may include bismuth oxide and/or praseodymium oxide. By configuring as such, the rate of change of capacitance after high temperature load can be maintained low and the ESD resistance after high temperature load can be improved even more.

The intragranular segregation phase may include silver oxide. By configuring as such, the rate of change of capacitance after high temperature load can be maintained low and the ESD resistance after high temperature load can be improved even more.

An electronic device according to one embodiment of the present disclosure includes any one of the above-mentioned voltage non-linear resistor ceramic.

### BRIEF DESCRIPTION OF DRAWINGS

FIG. 1 is a cross-section view of a multilayer chip varistor according to one embodiment of the present disclosure.

FIG. 2 is a schematic cross-section view of a part of a voltage non-linear resistor ceramic configuring an inner ceramic layer shown in FIG. 1.

FIG. 3 is a schematic view showing a method of obtaining an intragranular segregation distance ratio in the main phase grain which is a partially enlarged view of the cross-section shown in FIG. 2.

### DETAILED DESCRIPTION

Below describes exemplary embodiments of the present disclosure.

### Multilayer Chip Varistor

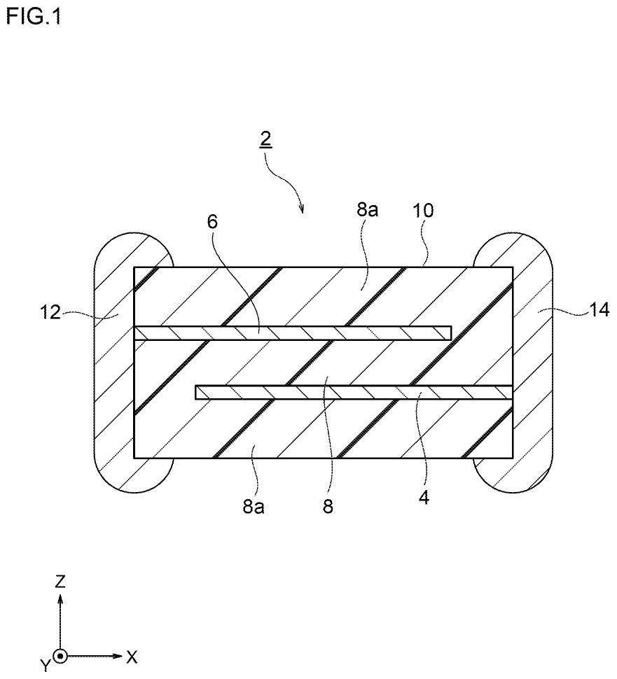

A non-linear resistor ceramic refers to a ceramic which a resistance value changes depending on the applied voltages. An electronic device according to one embodiment of the present disclosure includes a non-linear resistor ceramic. As shown in FIG. 1, a multilayer chip varistor 2 as one example of ceramic electronic devices includes an element main body 10 having a configuration in which internal electrode layers 4 and 6 are approximately parallel to a X-Y plane, and an inner ceramic layer 8 and an outer protective layer 8α are stacked in the Z-axis direction.

In the element main body 10, at both ends in the Z-axis direction (stacking direction) of the internal electrode layers 4 and 6 and inner ceramic layer 8, an outer protective layer 8a is provided to protect the inside of the element main body 10.

At both ends in the X-axis direction (layer direction) of this element main body 10, a pair of external terminal electrodes 12 and 14 is formed which electrically connects with the internal electrode layers 4 and 6 provided inside the element main body 10. Thereby, a varistor circuit is configured.

A shape of the element main body 10 is not particularly limited, and normally, the shape is rectangular parallelepiped shape, however, it may be any other shape. Also, a dimension of the element main body 10 is not particularly limited, and it may be any appropriate dimension depending on usage; and normally, it is about a vertical length (0.6 mm to 5.6 mm)× a transverse length (0.3 mm to 5.0 mm)× a thickness (0.3 mm to 1.9 mm).

Note that, in the present embodiment, the X-axis, the Y-axis, and the Z-axis are perpendicular to each other. Also, “stacking direction” refers to the Z-axis direction, and “layer direction” refers to a direction parallel to the X-axis and/or the Y-axis. Further, “inside/inner” refers to a side closer to a center of the multilayer chip varistor 2, and “outside/outer” means away from the center of the multilayer chip varistor 2.

### Internal Electrode Layer

A conductor included in the internal electrode layers 4 and 6 is not particularly limited, and preferably at least one selected from the group consisting of silver (Ag) and palladium (Pd) may be included. Also, the conductor may be configured of an Ag—Pd alloy. A thickness of each of the internal electrode layers 4 and 6 may be determined depending on usage, and normally, it is 0.5 μm to 5 μm or so.

### External Terminal Electrode

A conductor included in the external terminal electrodes 12 and 14 is not particularly limited, and preferably Ag, an Ag—Pd alloy, etc., may be used. A thickness of the external terminal electrodes 12 and 14 may be determined accordingly depending on usage, and normally, it is 10 μm to 50 μm or so.

### Inner Ceramic Layer

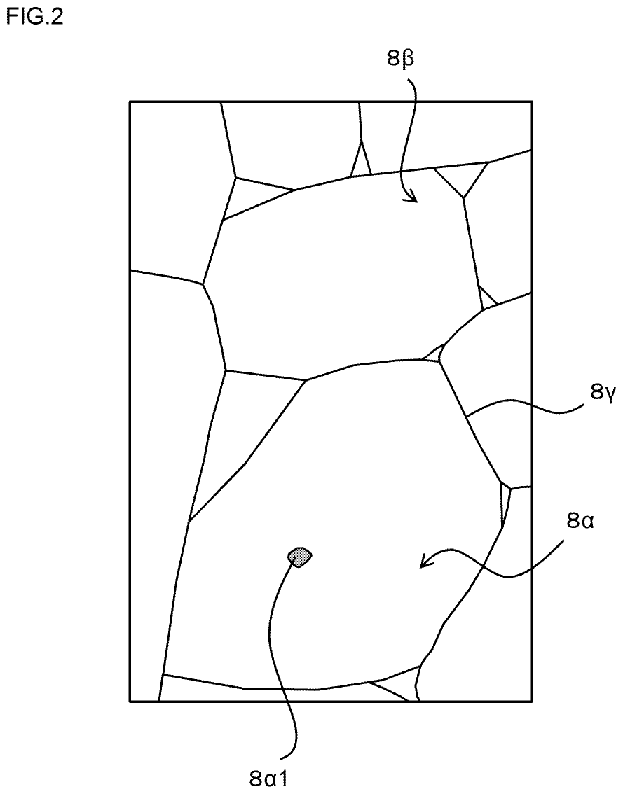

The inner ceramic layer 8 is also called an interlayer voltage non-linear resistor ceramic layer or a varistor layer. As shown in FIG. 2, the inner ceramic layer 8 is configured of a voltage non-linear resistor ceramic which includes a plurality of main phase grains 8α and 8β containing zinc oxide (ZnO) as a main component, and a grain boundary 8γ. The inner ceramic layer 8 including the main phase grains 8α and 8β and the grain boundary 8γ may contain, as a subcomponent, one or more selected from the group consisting of simple metals such as cobalt (Co), bismuth (Bi), rare earth metal elements, group IIIb elements, chromium (Cr), silicon (Si), molybdenum (Mo), antimony (Sb), alkali metal elements, and alkali earth metal elements. Also, oxides of these elements may be included as the subcomponent. Further, the main phase grains 8α and 8β and the grain boundary 8γ may include Ag.

An amount of ZnO as the main component of the inner ceramic layer 8 is not particularly limited, and preferably it may be 99.8 parts by weight to 69.0 parts by weight when an amount of all of the materials configuring the inner ceramic layer 8 is 100 parts by weight.

The inner ceramic layer 8 includes Sn as the subcomponent; and for example, Sn in terms of SnO₂ may be preferably 0.2 parts by weight or greater to 0.9 parts by weight or less, may be 0.32 parts by weight or greater to 0.78 parts by weight or less, or may be 0.42 parts by weight or greater to 0.68 parts by weight or less, with respect to 100 parts by weight of the main component ZnO.

Examples of the group IIIb elements which may be included as the subcomponent of the inner ceramic layer 8 include, boron (B), aluminum (Al), gallium (Ga), and indium (In). A content ratio of these elements is not particularly limited, and preferably it may be 0.0004 parts by weight or greater to 6.00 parts by weight or less in terms of oxide when the amount of ZnO is 100 parts by weight.

Examples of the alkali metal elements which may be included as the subcomponent of the inner ceramic layer 8 include lithium (Li), sodium (Na), potassium (K), rubidium (Rb), and cesium (Cs). A content ratio of these elements is not particularly limited, and preferably it may be 0 parts by weight or greater to 0.20 parts by weight or less, or may be 0.01 parts by weight or greater to 0.10 parts by weight or less in terms of oxide when the amount of ZnO is 100 parts by weight.

Examples of the alkali earth metal elements which may be included as the subcomponent of the inner ceramic layer 8 include magnesium (Mg), calcium (Ca), strontium (Sr), and barium (Ba). A content ratio of these elements is not particularly limited, and preferably it may be 0 parts by weight or greater to 0.30 parts by weight or less, or may be 0.05 parts by weight or greater to 0.20 parts by weight or less when the amount of ZnO is 100 parts by weight.

Examples of the rare earth metal elements which may be included as the subcomponent of the inner ceramic layer 8 include praseodymium (Pr). The rare earth metal elements function as substances to readily exhibit a varistor property. When an amount of elements other than oxygen, carbon, and nitrogen included in the inner ceramic layer 8 is 100 atom %, the amount of rare earth metal elements in the inner ceramic layer 8 is not particularly limited, and preferably it may be 0 atom % to 10 atom % or so, or may be 0.01 atom % to 10 atom % or so.

Various conditions such as the number of layers being stacked and a thickness of the inner ceramic layer 8 may be determined depending on purpose and usage. In the present embodiment, for example, the thickness of the inner ceramic layer 8 is about 5 μm to 100 μm, and the number of layers being stacked is about 1 to 50 layers or so.

### Outer Protective Layer

In the present embodiment, “inner ceramic layer 8” and “outer protective layer 8α” may be together referred to as “ceramic layer”. A material of the outer protective layer 8a may be the same as or different from the material of the inner ceramic layer 8. A thickness of the outer protective layer 8α may for example be 100 μm to 500 μm or so.

### Main Phase Grain

As shown in FIG. 2, the main phase grain 8α, which is at least one of the main phase grains 8α and 8β, includes an intragranular segregation phase 8α1 inside the main phase grain 8α; and, the intragranular segregation phase 8α1 includes an oxide containing Sn. Note that, the main phase grain 8β which does not include the intragranular segregation phase 8α1 in the grain may be included as the main phase grains configuring the inner ceramic layer 8 shown in FIG. 1.

A method of verifying the intragranular segregation phase 8α1 in the main phase grain 8α is not particularly limited. For example, it may be determined based on differences in luminance (or brightness) of a STEM-BF image obtained by observing the cross section of the voltage non-linear resistor ceramic using a scanning transmission electron microscope; or, it may be determined based on an element mapping image obtained using an energy dispersive X-ray spectrometer (EDS) or so. For example, a luminance differing area which is observed based on the difference in luminance (or brightness) of the STEM-BF image and the part exhibiting higher Sn concentration (for example, higher by two times or more) compared to an intragranular composition around said area may be deemed the intragranular segregation phase 8α1.

The intragranular segregation phase 8α1 of the main phase grain 8α includes Zn and Sn. A weight ratio of Sn with respect to Zn (Sn/Zn) in the intragranular segregation phase 8α1 in terms of SnO₂ and ZnO preferably may be 0.9% or greater to 3.1% or less, may be 1.0% or greater to 3.0% or less, may be 1.2% or greater to 2.9% or less, may be 1.3% or greater to 2.6% or less, or may be 1.8% or greater to 2.3% or less.

Also, other than Zn and Sn, the intragranular segregation phase 8α1 may include one or more rare earth elements such as Co, Bi, Al, Cr, Si, Ag, and Pr. Note that, the intragranular segregation phase 8α1 of the main phase grain 8α at least includes Zn and Sn. A weight ratio (A/Zn) of other subcomponents (A), which does not include Sn, with respect to Zn in the intragranular segregation phase 8α1 may be 0.23% or less in terms of oxide; however, it is not limited to this.

An element analysis can be performed using a combination of a scanning electron microscope (SEM) and EDS (SEM-EDS), a combination of a scanning transmission electron microscope (STEM) and EDS (STEM-EDS), an inductively coupled plasma mass spectrometry (ICP-MS), a laser abrasion inductively coupled plasma mass spectrometry (LA-ICP-MS), etc.

A size of the main phase grain 8α is not particularly limited, and for example in a circle equivalent diameter, it may preferably be between 0.5 and 10.0 μm, and more preferably it may be 1.0 to 5.0 μm. Also, an intragranular segregation area ratio is not particularly limited which represents a ratio of an area of the intragranular segregation phase 8α1 with respect to an area of the main phase grain 8α in an observed cross section of the voltage non-linear resistor ceramic. Preferably, the intragranular segregation area ratio may be 0.07% or greater to 18% or less, may be 0.1% or greater to 15% or less, may be 1.0% or greater to 13% or less, or may be 1.5% or greater to 12% or less. A size of the main phase grain 8α1 is not particularly limited, and for example, in a circle equivalent diameter, it may preferably be 0.1 μm or greater. Note that, a size of the main phase grain 8β which does not include the intragranular segregation phase is preferably about the same as the main phase grain 8α; however, it may be different.

Also, an intragranular segregation distance ratio represents a ratio of a shortest distance between an outer circumference of the main phase grain 8α and an outer circumference of the intragranular segregation phase 8α1 with respect to a grain size of the main phase grain 8α including the intragranular segregation phase. The intragranular segregation distance ratio is not particularly limited, and preferably it may be 3.0% or greater to 49% or less, or may be 3.0% or greater to 28% or less. The intragranular segregation distance ratio can be obtained using a method described below.

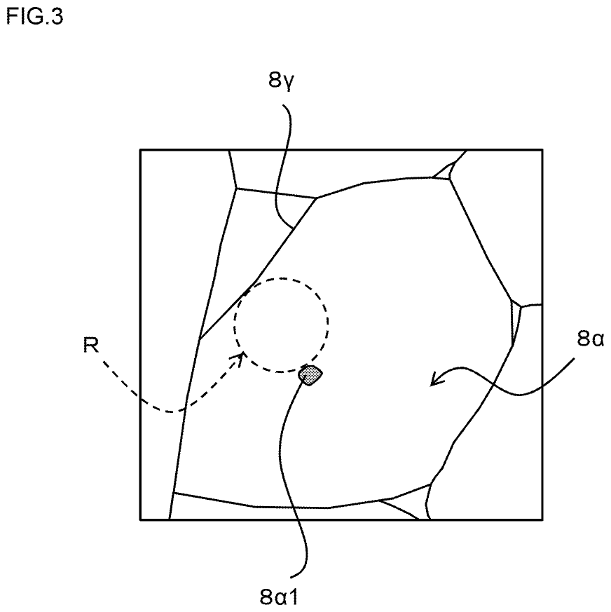

As show in FIG. 3, in the cross section of the inner ceramic layer 8, a virtual circle R is drawn which circumscribes one of the main phase grain 8α and also inscribes the main phase grain 8α including the intragranular segregation phase 8α1 in said main phase grain 8α. Then, a circle having a smallest diameter is obtained, and this is divided by a circle equivalent diameter of the main phase grain 8α. Thereby, the intragranular segregation distance ratio can be obtained.

When obtaining the intragranular segregation area ratio and the intragranular segregation distance ratio, a range of a measuring area is not necessarily limited as long as it includes the inner ceramic layer 8 which is disposed between the pair of internal electrode layers 4 and 6. For example, the measuring range can be set so that the cross section of the inner ceramic layer is 45 μm² or greater. Also, as the intragranular segregation area ratio and the intragranular segregation distance ratio, it is possible to use a representative value obtained from an average calculated based on the measurements from 10 or more main phase grains 8α.

Note that, below is used to determine whether the segregation phase is the intragranular segregation phase 8α1. That is, in the case that the segregation phase is not contacting the grain boundary 8γ, and the segregation phase is observed inside the main phase grain by 1% or greater, or preferably 3% or greater in terms of the aforementioned intragranular segregation distance ratio than the grain boundary 8γ; then, the segregation phase is deemed the intragranular segregation phase 8α1. One intragranular segregation phase 8α1 may be in one main phase grain 8α, and two or more intragranular segregation phases 8α1 may be in one main phase grain 8α.

The number ratio (or area ratio) of the main phase grain 8α including the intragranular segregation phase 8α1 among the main phase grains 8α and 8β may preferably be 5% or more, more preferably may be 10% or more to 30% or less in total of 100 or more grains 8α and 8β in the cross section.

### Method for Manufacturing Multilayer Chip Varistor

Next, one example of a method for manufacturing a multilayer chip varistor 2 according to the present embodiment is described.

In the present embodiment, a green chip is made using a normal screen-printing method using a paste, and then the green chip is fired. Then, external terminal electrodes 12 and 14 are printed or transferred and then fired; thereby, the multilayer chip varistor is manufactured. Below describes a method for manufacturing the varistor is described.

First, a ceramic layer paste, an internal electrode layer paste, and an external terminal electrode paste are prepared.

The ceramic layer paste may be an organic paste obtained by kneading raw materials for the voltage non-linear resistor ceramic and an organic vehicle, or it may be a water-based paste.

As the raw materials for the voltage non-linear resistor ceramic, oxides, the mixture thereof, and composite oxides of the main component and the subcomponent of the inner ceramic layer 8 can be used. Furthermore, various compounds which become the above-mentioned oxides and the composite oxides by firing can be selected accordingly and mixed for use. Examples include carbonate, oxalates, nitrates, hydroxides, organometallic compounds, etc.

The amount of each component in the raw materials of the voltage non-linear resistor ceramic may be determined so that the main phase grain 8α includes the intragranular segregation phase 8α1 including Zn and Sn. Also, by changing the components included in the intragranular segregation phase 8α1, a ratio of components included in the intragranular segregation phase 8α1 changes. As these raw material powders, those having an average particle size 0.3 μm to 2 μm or so is used.

The organic vehicle is obtained by dissolving the binder in the organic solvent. The binder used for the organic vehicle is not particularly limited, and the binder may be selected accordingly from normal various binders such as ethyl cellulose and polyvinyl butyral. The organic solvent used for the organic vehicle is not particularly limited, and depending on the methods used such as a printing method and a sheet method, the organic solvent may be selected accordingly from various organic solvents such as terpineol, butyl carbitol, acetone, and toluene.

Also, in the case of using the water-based paste as the ceramic layer paste, a water-based vehicle, which is obtained by dissolving an aqueous binder, a dispersant, etc., in water, may be kneaded with the voltage non-linear resistor ceramic. The aqueous binder is not particularly limited, and for example, polyvinyl alcohol, cellulose, an aqueous acrylic resin, etc., may be used.

The internal electrode layer paste is prepared by kneading the above-mentioned organic vehicle with the above-mentioned various conductors or various oxides, organometallic compounds, resinates, etc., which become the above-mentioned conductors after firing. Also, the external terminal electrode paste may be prepared similarly to this internal electrode layer paste.

The amount of the organic vehicle in each of the above-mentioned pastes is not particularly limited, and the amount may be a normal amount. For example, the binder may be 1 mass % to 5 mass %, and the solvent may be 10 mass % to 50 mass %. Also, depending on needs, each paste may contain an additive selected from various dispersants, plasticizers, dielectrics, insulation materials, etc. A total content of these preferably may be 10 mass % or less.

Next, a green chip is manufactured. The green chip may be manufactured using a sheet lamination method or using a sheet printing method.

The sheet lamination method is performed in the below order. The ceramic layer paste is used to form the green sheet, and then a predetermined number of green sheets is laminated to form a green outer protective layer 8a. Next, on this outer protective layer 8a, the internal electrode layer paste is printed in a predetermined pattern to form a green internal electrode layer 4.

Further, on the internal electrode layer 4, a predetermined number of green sheets is laminated to form a green inner ceramic layer 8. Next, on this green inner ceramic layer 8, the internal electrode layer paste is printed in a predetermined pattern to form a green internal electrode layer 6. The internal electrode layers 4 and 6 are printed so that these are exposed to different end surfaces of the element main body facing each other.

Lastly, on the internal electrode layer 6, a predetermined number of green sheets is laminated to form a green outer protective layer 8α. Then, while heating, pressure is applied to perform pressure adhesion, and then a laminated body is cut into a predetermined shape. Then, the laminated body cut into a predetermined shape is released from the substrate to give a green chip.

The sheet printing method is performed in the below order. The ceramic layer paste is printed in a predetermined thickness for several times on a substrate such as PET to form a green outer protective layer 8a. Next, on this outer protective layer 8a, the internal electrode layer paste is printed in a predetermined pattern to form a green internal electrode layer 4.

Next, on this internal electrode layer 4, similarly to the above, the ceramic layer paste is printed in a predetermined thickness for several times to form a green inner ceramic layer 8. Next, on the green inner ceramic layer 8, the internal electrode layer paste is printed in a predetermined pattern to form a green internal electrode layer 6. The internal electrode layers 4 and 6 are printed so that these are exposed to different end surfaces of the element main body 10 facing each other.

Lastly, on the internal electrode layer 6, similarly to the above, the ceramic layer paste is printed in a predetermined thickness for several times to form a green outer protective layer 8a. Next, while heating, pressure is applied to perform pressure adhesion, and then, a laminated body is cut into a predetermined shape. Then, the laminated body cut into a predetermined shape is released from the substrate to give a green chip.

The green chip obtained using the above-mentioned methods is subjected to a binder removal treatment and firing to give a sintered body (element main body 10).

The binder removal treatment for the green chip may be performed under normal conditions. For example, the conditions may be in air atmosphere, a temperature increasing rate of 5° C./hour to 300° C./hour or so, a holding temperature of 180° C. to 400° C. or so, and a temperature holding time of 0.5 hours to 24 hours.

Regarding the firing of the green chip, for example, during the temperature increasing step in which the temperature increases from room temperature to the holding temperature, preferably the conditions may be in air or oxygen atmosphere, and a temperature increasing rate may be 50° C./hour to 500° C./hour. Regarding the temperature holding step in which the temperature is held at the holding temperature, preferably the conditions may be in air or oxygen atmosphere, a holding temperature may be 800° C. to 1400° C., and a temperature holding time may be 0.5 to 8 hours.

In a temperature decreasing step which is performed subsequently to cool the temperature to room temperature, preferably the conditions may be in air, and a temperature increasing rate may be 50° C./hour to 500° C./hour. By setting at least one of the temperature increasing step (first firing step) or the temperature holding step (second firing step) under oxygen atmosphere, it is possible to generate the intragranular segregation phase 8α1 in the main phase grain 8α. Although the reason for this is not necessarily clear, the following is thought as a possible reason.

By setting the atmosphere to oxygen atmosphere during the temperature increasing step and the temperature holding step during which the grain growth of zinc oxide is facilitated, it is thought that zinc oxide readily incorporates the subcomponent. Also, by adjusting the oxygen amount of the oxygen atmosphere, it is possible to control the position of the intragranular segregation phase 8α1 in the main phase grain 8α. Note that, “oxygen atmosphere” refers to the atmosphere having a higher oxygen concentration than that in air, for example, the oxygen atmosphere has an oxygen concentration of 50 to 100%.

By setting the holding temperature at 800° C. or higher, densification of the green chip can sufficiently proceed easily. By setting the holding temperature at about 1400° C. or lower, it becomes easier to prevent abnormal sintering and disconnected electrodes of the internal electrode layers 4 and 6.

The sintered body (element main body 10) obtained as such, for example, is subjected to an end surface polishing using a barrel polishing, sand blast, etc., and the external terminal electrode paste is coated and fired to form the external terminal electrodes 12 and 14. For example, the firing conditions of the external terminal electrode paste may preferably be in air atmosphere at a temperature of 600° C. to 800° C. for 10 minutes to 1 hour.

The multilayer chip varistor 2 according to the present embodiment manufactured as such, for example, is connected to a high-speed transmission circuit, etc., and the multilayer chip varistor 2 absorbs or removes externally induced surge (abnormal voltage) such as statics to protect the circuit, etc.

In the voltage non-linear resistor ceramic according to the present embodiment, the segregation phase does not exist around the main phase grain 8β, rather the segregation phase (intragranular segregation phase 8α1) exists inside the main phase grain 8α. By using the voltage non-linear resistor ceramic of this embodiment to the inner ceramic layer 8, it is possible to obtain the varistor 2 having a small rate of change of capacitance after high temperature load and an excellent ESD resistance after high temperature load.

Particularly, the intragranular segregation phase 8α1 includes zinc oxide and tin oxide, and a weight ratio of tin oxide with respect to zinc oxide in terms of SnO₂ and ZnO may preferably be 0.9% or greater to 3.1% or less, may be 1.0% or greater to 3.0% or less, may be 1.2% or greater to 2.9% or less, or may be 1.3% or greater to 2.6% or less. When the weight ratio of tin oxide with respect to zinc oxide is within such range, a particularly excellent ESD resistance after high temperature load is achieved and a rate of change of capacitance becomes even smaller.

Also, a ratio of a cross-section area of the intragranular segregation phase 8α1 with respect to a cross-section area of the main phase grain 8α including the intragranular segregation phase 8α1 may preferably be 0.07% or greater to 18% or less, may be 0.07% or greater to 17% or less, may be 0.09% or greater to 16% or less, or 0.1% or greater to 15% or less. When the ratio of the above-mentioned cross-section areas is within such range, an excellent ESD resistance after high temperature load is achieved and a rate of change of capacitance becomes even smaller.

Further, in the cross section of the voltage non-linear resistor ceramic, a ratio of a shortest distance between an outer circumference of the cross section of the main phase grain and the outer circumference of the cross section of the intragranular segregation phase with respect to a grain size of the cross section of the main phase grain including the intragranular segregation phase may preferably be 3.0% or greater to 49% or less, or 3.0% or greater to 28% or less. When such ratio is within said range, an excellent ESD resistance after high temperature load is achieved and a rate of change of capacitance becomes even smaller.

Further, the intragranular segregation phase 8α1 may include one or more selected from the group consisting of cobalt oxide, chromium oxide, silicon oxide, silver oxide, bismuth oxide, and praseodymium oxide. By configuring as such, a rate of change of capacitance after high temperature load can be maintained low and an ESD resistance after high temperature load can be further improved.

The intragranular segregation phase 8α1 may include bismuth oxide and/or praseodymium oxide. By configuring as such, a rate of change of capacitance after high temperature load can be maintained low and an ESD resistance after high temperature load can be improved even more.

The intragranular segregation phase 8α1 may include silver oxide. By configuring as such, a rate of change of capacitance after high temperature load can be maintained low and an ESD resistance after high temperature load can be improved even more.

Hereinabove, the embodiments of the present disclosure have been described; however, the present disclosure is not limited to these embodiments, and various other embodiments are possible within the range which does not exceed the gist of the present disclosure.

For example, as shown in FIG. 1, the multilayer chip varistor 2 is not limited to the embodiment having only one pair of internal electrode layers 4 and 6. In FIG. 1, only one pair of internal electrode layers 4 and 6 is shown; however, the multilayer chip varistor may have a plurality of pairs of internal electrode layers.

Also, in the above-mentioned embodiment, the multilayer chip varistor is used as an example of the electronic device according to the present disclosure; however, as the electronic device of the present disclosure having the voltage non-linear resistor ceramic, it is not limited to the multilayer chip varistor. The electronic device of the present disclosure may be any electronic device having the inner ceramic layer and the internal electrode layer, or it may be a single layer varistor having the external terminal electrode provided to a bulk ceramic main body configured of voltage non-linear resistor ceramic.

### EXAMPLES

Hereinafter, the present disclosure is described based on the detailed examples; however, the present disclosure is not limited to these examples.

### Example 1

First, raw materials of Zn, Co, Bi, Sn, Al, Pr, Cr, and Si were prepared. As the raw material of Zn, ZnO was prepared. The raw materials of Co, Bi, Sn, Al, Pr, Cr, and Si were prepared by accordingly selecting an oxide of each element or a compound which becomes the oxide of each element after firing. Examples of the compound which becomes the oxide of each element after firing include carbonates and hydrates of carbonates.

Next, these raw materials were mixed so that each raw material in a composition of an inner ceramic layer 8 after being fired satisfied a ratio shown in Table 1A in terms of CoO, Bi₂O₃, SnO₂, Al₂O₃, Pr₆O₁₁, Cr₂O₃, and SiO₂ with respect to 100 parts by weight of ZnO. Thereby, a voltage non-linear resistor material was obtained.

The voltage non-linear resistor raw material, an organic binder, an organic solvent, and a plasticizer were added and wet-mixed for about 20 hours using a ball mill to give a ceramic layer paste.

The ceramic layer paste was printed in a thickness of 11 μm for several times on a PET film to form a green outer protective layer 8a.

On this green outer protective layer 8a, an internal electrode layer paste was printed in a desired shape using a screen-printing method and then dried to form a green internal electrode layer 4. Note that, the internal electrode layer paste was manufactured by wet-mixing the above-mentioned organic binder, an organic solvent, and oxides of Ag.

Further, the ceramic layer paste was printed for several times to form a green inner ceramic layer 8. Next, similarly to the above, the green internal electrode layer 6 and the green outer protective layer 8a were formed to give a green multilayer body.

After heating and pressure adhering the green multilayer body, the green multilayer body was cut into a predetermined chip shape to give a green chip.

The green chip was subjected to a binder removal treatment in a firing furnace having a chamber size of 10 L under the conditions of a temperature at 350° C. for 2 hours. Then, the firing was performed under the conditions shown in Table 1A to obtain a sintered body which becomes an element main body 10. That is, in Example 1, the temperature was increased to 900° C. at a temperature increasing rate of 200° C./hr under oxygen atmosphere having a flow rate of 1.0 L/min (temperature increasing step), and the temperature was maintained at 900° C. for one hour under oxygen atmosphere having a flow rate of 1.0 L/min (holding step). Then, the temperature was decreased to room temperature at temperature decreasing rate of 200° C./hr under air atmosphere having a flow rate of 1.0 L/min (temperature decreasing step).

Next, to both ends of the obtained sintered body, a silver paste which was manufactured by wet-mixing the organic solvent and the oxides of silver was applied and baked at 800° C. to form external terminal electrodes 12 and 14. Thereby, a multilayer chip varistor 2 (varistor sample) having the cross-section configuration shown in FIG. 1 was obtained. A size of the varistor sample was 1.0 mm×0.5 mm×0.5 mm. Also, it was confirmed using a LA-ICP-MS that average compositions of the voltage non-linear resistor before and after sintering were the same.

Using the obtained varistor sample, a segregation phase was observed, and a rate of change of capacitance and an ESD resistance were measured.

First, the varistor sample was embedded in the resin and fixed; and polishing was performed to obtain a cross-section which included at least a pair of internal electrode layers 4 and 6; and, the varistor sample was polished so as to expose a cross-section surface in a stacking direction of the inner ceramic layer 8 and the internal electrode layers 4 and 6.

Next, an observation sample including the inner ceramic layer 8 and the internal electrode layers 4 and 6 used for an electron microscope observation was prepared by using a focused ion beam (FIB) device to the above-obtained cross section. Regarding this sample, the cross-sections of the inner ceramic layer 8 and the internal electrode layers 4 and 6 were observed using STEM (JEM2100F made by JEOL, accelerating voltage 200 kV) and an image shown in FIG. 2 was obtained at a magnification of 4000×. Based on an image which was element mapped using EDS, the inner ceramic layer 8, the internal electrode layers 4 and 6, main phase grains 8α and 8β, and an intragranular segregation phase 8α1 in the main phase grain 8α were verified, and the positions of these were determined. Regarding ten or more randomly selected main phase grains 8α, using an image analysis method, a ratio of an area of the intragranular segregation phase(s) 8α1 with respect to an area of said main phase grains 8α were calculated (i.e., an intragranular segregation area ratio was calculated). Also, using an image analysis method shown in FIG. 3, an intragranular segregation distance ratio was obtained. Results are shown in Table 1B.

Further, regarding the ten or more randomly selected main phase grains 8α, a composition analysis was carried out using an EDS point analysis to obtain an average of weight ratios of Sn in terms of SnO₂ with respect to a weight of Zn in terms of ZnO in the intragranular segregation phase(s) 8α1 of the main phase grains 8α (i.e., an intragranular segregation wt % ratio was obtained). Results are shown in Table 1B.

### Rate of Change of Capacitance ΔC

To a LCR meter, frequency of 1 kHz and input signal (measuring voltage) of 1 Vrms were input to measure a capacitance C1 of the varistor sample. The varistor sample was connected to DC constant voltage power supply and voltage of 12V was applied at 130° C. for 200 hours. Then, a capacitance C2 was measured under the same conditions as C1. A rate of change of capacitance ΔC was obtained using ΔC (%)=|C1−C2|/C1×100. In the present example, ΔC of 30% or less was deemed favorable, and it was deemed even more favorable in the order of 25% or less, 20% or less, and 15% or less. Results are shown in Table 1B.

### ESD Resistance After High Temperature Load

First, a varistor sample 2 was connected to DC constant voltage power supply, and when current of 1 mA flew in the varistor sample 2, the voltage acting between the electrodes of the varistor sample 2 was measured using a voltmeter. The measured value was deemed a varistor voltage before testing (V1 mA_before).

Next, each varistor sample was connected to DC constant voltage power supply and voltage of 12V was applied at 130° C. for 200 hours. Then, in order to determine the ESD resistance (unit kV) of each varistor sample, a plurality of varistor samples was prepared and was subjected to an electrostatic discharge immunity test defined in IEC61000-4-2 of IEC (International Electrotechnical Commission). The test was performed by applying a different voltage (2 kV, 4 kV, 6 kV, 8 kV, 10 kV, and 15 kV) to each varistor sample. Conditions of the electrostatic discharge immunity test other than the voltage were as described below.

That is, using a capacitor-type electrostatic simulator having a charging capacitor of 150 pF and a discharge resistance of 330Ω, a predetermined ESD voltage charged in the electrostatic simulator was applied by contact discharge to the varistor sample mounted on an evaluation substrate. The voltage was applied in 1 second interval for 10 times in (+) direction and 10 times in (−) direction. Then, per each varistor sample with a different applied voltage, a varistor voltage after testing (V1 mA_after) was obtained similarly to the above.

Further, per each varistor sample with a different applied voltage, a degradation rate of the varistor voltage was obtained using the below formula. The lower the degradation rate of the varistor voltage, the better the ESD resistance property.

$$100 \times \{ \vert 1 - ( V1mA\_after ) \vert / ( V1mA\_before ) \} [ \% ]$$

In the present example, the maximum applied voltage (unit kV) when the degradation rate of the varistor voltage was 10% or less was deemed the ESD resistance after high temperature load. The ESD resistance after high temperature load of 5 kV or greater was deemed favorable, and it was deemed even more favorable in the order of 8 kV or greater, 10 kV or greater, and 15 kV or greater. Results are shown in Table 1B.

### Examples 2 to 11 and Comparative Examples 1 and 2

Varistor samples were manufactured similarly to Example 1 and the similar evaluations as Example 1 were carried out, except that a ratio of the subcomponent SnO₂ was changed to that shown in Table 1A and the conditions (atmosphere and a gas flow rate) of the firing step were changed as shown in Table 1A. Results are shown in Table 1B.

### Examples 13 to 22

The ratios of SnO₂, CoO, Bi₂O₃, Al₂O₃, Pr₆O₁₁, Cr₂O₃, and SiO₂ of the subcomponent were changed as shown in Table 1A. Also, the firing was performed under the conditions shown in Table 1A to obtain a sintered body which becomes an element main body 10. That is, the temperature was increased to 900° C. at a temperature increasing rate of 200° C./hr under oxygen atmosphere having a flow rate of 2.0 L/min, and the temperature was maintained at 900° C. for one hour under air atmosphere having a flow rate of 2.0 L/min. Then, the temperature was decreased to room temperature at a temperature decreasing rate of 200° C./hr under air atmosphere having a flow rate of 2.0 L/min. The varistor sample was manufactured similarly to Example 1 except for the above-mentioned points, and the similar evaluations as Example 1 were carried out. Results are shown in Table 1B.

Regarding the intragranular segregation phase 8α1 of the main phase grain 8α of each sample, an average ratio of a total weight of below components (Co, Bi, Al, Pr, Cr, and Si) with respect to a weight of Zn in terms of ZnO in the intragranular segregation phase 8α1 was obtained. Results are shown in Table 1B.
Example 13: Co₃O₄
Example 14: Cr₂O₃
Examples 15: SiO₂
Example 16: Co₃O₄+Cr₂O₃+SiO₂
Example 17: Co₃O₄+Cr₂O₃+SiO₂+Bi₂O₃
Example 18: Co₃O₄+Cr₂O₃+SiO₂+Pr₆O₁₁
Example 19: Co₃O₄+Cr₂O₃+SiO₂+Bi₂O₃+Pr₆O₁₁
Example 20: Co₃O₄+Cr₂P₃+SiO₂+Bi₂P₃+AgO
Example 21: Co₃O₄+Cr₂O₃+SiO₂+Pr₆O₁₁+AgO
Example 22: Co₃O₄+Cr₂O₃+SiO₂+Bi₂O₃+Pr₆O₁₁+AgO

TABLE 1A

| | | | | | | | | | Firing condition | | | | | |
|---|---|---|---|---|---|---|---|---|---|---|---|---|---|---|
| | | | | | | | | | Temparature | | Temperature | | Temperature | |
| | Main | | | | | | | | increasing | | maintaining | | decreasing | |
| | component | Subcomponent | | | | | | | condition | | condition | | condition | |
| | ZnO | CoO | Bi2O3 | SnO2 | Al2O3 | Pr6O11 | Cr2O3 | SiO2 | Atmo- | | Atmo- | | Atmo- | |
| | wt % | wt % | wt % | wt % | wt % | wt % | wt % | wt % | sphere | L/min | sphere | L/min | sphere | L/min |
| Comparative | 100 | 1.5 | 0.1 | 0.10 | 0.001 | 0.1 | 0.01 | 0.1 | Air | 1.0 | Air | 1.0 | Air | 1.0 |
| example 1 | | | | | | | | | | | | | | |
| Comparative | 100 | 1.5 | 0.1 | 1.00 | 0.001 | 0.1 | 0.01 | 0.1 | Air | 2.0 | Air | 2.0 | Air | 2.0 |
| example 2 | | | | | | | | | | | | | | |
| Example 1 | 100 | 1.5 | 0.1 | 0.2 | 0.001 | 0.1 | 0.01 | 0.1 | O2 | 1.0 | O2 | 1.0 | Air | 1.0 |
| Example 2 | 100 | 1.5 | 0.1 | 0.90 | 0.001 | 0.1 | 0.01 | 0.1 | O2 | 1.5 | O2 | 1.5 | Air | 1.5 |
| Example 3 | 100 | 1.5 | 0.1 | 0.25 | 0.001 | 0.1 | 0.01 | 0.1 | O2 | 1.0 | O2 | 1.0 | Air | 1.0 |
| Example 4 | 100 | 1.5 | 0.1 | 0.85 | 0.001 | 0.1 | 0.01 | 0.1 | O2 | 1.5 | O2 | 1.5 | Air | 1.5 |
| Example 5 | 100 | 1.5 | 0.1 | 0.30 | 0.001 | 0.1 | 0.01 | 0.1 | O2 | 1.0 | O2 | 1.0 | Air | 1.0 |
| Example 6 | 100 | 1.5 | 0.1 | 0.80 | 0.001 | 0.1 | 0.01 | 0.1 | O2 | 1.5 | O2 | 1.5 | Air | 1.5 |
| Example 7 | 100 | 1.5 | 0.1 | 0.32 | 0.001 | 0.1 | 0.01 | 0.1 | O2 | 1.0 | O2 | 1.0 | Air | 1.0 |
| Example 8 | 100 | 1.5 | 0.1 | 0.78 | 0.001 | 0.1 | 0.01 | 0.1 | O2 | 1.5 | O2 | 1.5 | Air | 1.5 |
| Example 9 | 100 | 1.5 | 0.1 | 0.40 | 0.001 | 0.1 | 0.01 | 0.1 | O2 | 1.0 | Air | 1.0 | Air | 1.0 |
| Example 10 | 100 | 1.5 | 0.1 | 0.70 | 0.001 | 0.1 | 0.01 | 0.1 | O2 | 1.5 | O2 | 1.0 | Air | 1.5 |
| Example 11 | 100 | 1.5 | 0.1 | 0.42 | 0.001 | 0.1 | 0.01 | 0.1 | O2 | 1.0 | Air | 1.0 | Air | 1.0 |
| Example 12 | 100 | 1.5 | 0.1 | 0.68 | 0.001 | 0.1 | 0.01 | 0.1 | O2 | 1.5 | O2 | 1.5 | Air | 1.5 |
| Example 13 | 100 | 3.0 | 0.1 | 0.50 | 0.001 | 0.1 | 0.01 | 0.1 | O2 | 2.0 | Air | 2.0 | Air | 2.0 |
| Example 14 | 100 | 1.5 | 0.1 | 0.50 | 0.001 | 0.1 | 0.1 | 0.1 | O2 | 2.0 | Air | 2.0 | Air | 2.0 |
| Example 15 | 100 | 1.5 | 0.1 | 0.50 | 0.001 | 0.1 | 0.01 | 0.2 | O2 | 2.0 | Air | 2.0 | Air | 2.0 |
| Example 16 | 100 | 3.0 | 0.1 | 0.50 | 0.001 | 0.1 | 0.1 | 0.2 | O2 | 2.0 | Air | 2.0 | Air | 2.0 |
| Example 17 | 100 | 3.0 | 1.0 | 0.50 | 0.001 | 0.1 | 0.1 | 0.2 | O2 | 2.0 | Air | 2.0 | Air | 2.0 |
| Example 18 | 100 | 3.0 | 0.1 | 0.50 | 0.001 | 0.3 | 0.1 | 0.2 | O2 | 2.0 | Air | 2.0 | Air | 2.0 |
| Example 19 | 100 | 3.0 | 1.0 | 0.50 | 0.001 | 0.3 | 0.1 | 0.2 | O2 | 2.0 | Air | 2.0 | Air | 2.0 |
| Example 20 | 100 | 3.0 | 1.0 | 0.50 | 0.001 | 0.1 | 0.1 | 0.2 | O2 | 2.0 | Air | 2.0 | Air | 2.0 |
| Example 21 | 100 | 3.0 | 0.1 | 0.50 | 0.001 | 0.3 | 0.1 | 0.2 | O2 | 2.0 | Air | 2.0 | Air | 2.0 |
| Example 22 | 100 | 3.0 | 1.0 | 0.50 | 0.001 | 0.3 | 0.1 | 0.2 | O2 | 2.0 | Air | 2.0 | Air | 2.0 |

TABLE 1B

| | | | | | | Rate of | ESD |
|---|---|---|---|---|---|---|---|
| | | | | | | change of | resistance |
| | Main phase grain including intragranular segregation phase | | | | | capacitance | (nondegregating |
| | | Intragranular | | | | after high | voltage) |
| | | segregation | Subcomponent | Intragranular | Intragranular | temperature | after high |
| | Component of | wt % ratio | oxide excluding | segregation | segregation | load | temperature |
| | intragranular | SnO2/ZnO | SnO2/ZnO | area ratio | distance ratio | Δ C | load |
| | segregation phase | (wt %/wt %) | (wt %/wt %) | (%) | (%) | (%) | (kV) |
| Comparative | — | — | — | — | — | 31 | 4 |
| example 1 | | | | | | | |
| Comparative | — | — | — | — | — | 32 | 4 |
| example 2 | | | | | | | |
| Example 1 | Zn, Sn | 0.9 | — | 0.08 | 49 | 30 | 6 |
| Example 2 | Zn, Sn | 3.1 | — | 18 | 29 | 30 | 6 |
| Example 3 | Zn, Sn | 1.0 | — | 0.07 | 38 | 25 | 6 |
| Example 4 | Zn, Sn | 3.0 | — | 17 | 29 | 25 | 6 |
| Example 5 | Zn, Sn | 1.2 | — | 0.09 | 49 | 21 | 6 |
| Example 6 | Zn, Sn | 2.9 | — | 16 | 30 | 21 | 6 |
| Example 7 | Zn, Sn | 1.3 | — | 0.1 | 48 | 20 | 6 |
| Example 8 | Zn, Sn | 2.6 | — | 15 | 31 | 20 | 6 |
| Example 9 | Zn, Sn | 1.8 | — | 1.0 | 3.1 | 16 | 6 |
| Example 10 | Zn, Sn | 2.3 | — | 13 | 29 | 16 | 6 |
| Example 11 | Zn, Sn | 1.9 | — | 1.5 | 3.0 | 15 | 6 |
| Example 12 | Zn, Sn | 2.1 | — | 12 | 28 | 15 | 6 |
| Example 13 | Zn, Sn, (Co) | 2.1 | 0.12 | 2.0 | 27 | 15 | 8 |
| Example 14 | Zn, Sn, (Cr) | 2.0 | 0.07 | 1.9 | 27 | 15 | 8 |
| Example 15 | Zn, Sn, (Si) | 1.9 | 0.01 | 1.8 | 26 | 15 | 8 |
| Example 16 | Zn, Sn, (Co, Cr, Si) | 1.9 | 0.20 | 1.9 | 27 | 14 | 8 |
| Example 17 | Zn, Sn, (Co, Cr, Si, Bi) | 2.0 | 0.21 | 1.9 | 26 | 15 | 10 |
| Example 18 | Zn, Sn, (Co, Cr, Si, Pr) | 2.0 | 0.21 | 1.9 | 25 | 15 | 10 |
| Example 19 | Zn, Sn, (Co, Cr, Si, Bi, Pr) | 1.9 | 0.22 | 1.8 | 24 | 13 | 10 |
| Example 20 | Zn, Sn, (Co, Cr, Si, Bi, Ag) | 1.9 | 0.22 | 1.9 | 22 | 15 | 15 |
| Example 21 | Zn, Sn, (Co, Cr, Si, Pr, Ag) | 1.9 | 0.22 | 1.8 | 26 | 15 | 15 |
| Example 22 | Zn, Sn, (Co, Cr, Si, Bi, Pr, Ag) | 1.8 | 0.23 | 1.8 | 22 | 12 | 15 |

According to the results shown in Table 1B, the varistor sample according to each example had the main phase grain 8α including Sn oxides inside the main phase grain. Compared to comparative examples, such example exhibited a small rate of change of capacitance across before and after high temperature load and also exhibited an excellent ESD resistance after high temperature load.

Also, the weight ratio of SnO₂/ZnO in the main phase grain 8α (an intragranular segregation weight % ratio) was preferably 0.9% or greater to 3.1% or less; and, it was even more preferable in the order of 1.0% or greater to 3.0% or less, 1.3% or greater to 2.6% or less, and 1.8% or greater to 2.3% or less.

In the cross section, a ratio of an area of the intragranular segregation phase 8α1 with respect to an area of the main phase grain 8α including the intragranular segregation phase 8α1 (i.e., the intragranular segregation area ratio) was preferably 0.07% or greater to 18% or less; and, it was even more preferable in the order of 0.1% or greater to 15% or less, 1.0% or greater to 13% or less, and 1.5% or greater to 12% or less.

In the cross section, the intragranular segregation distance ratio of the main phase grain including the main phase grain 8α was preferably 3.0% or greater to 49% or less, and even more preferably 3.0% or greater to 28% or less.

Note that, in Comparative example 1, the segregation phase was neither observed in the grain nor in the grain boundary. The rate of change of capacitance before and after high temperature load was large, and the ESD resistance after high temperature load was low. In Comparative example 2, the segregation phase was observed only in the grain boundary. The rate of change of capacitance before and after high temperature load was large, and the ESD resistance after high temperature load was low.

### REFERENCE SIGNS LIST

2 . . . Multilayer chip varistor
4.6 . . . Internal electrode layer
8 . . . Inner ceramic layer
8α and 8β . . . Main phase grain
8α1 . . . Intragranular segregation phase
8γ . . . Grain boundary
8α . . . Outer protective layer
10 . . . Element main body

What is claimed is:

1. A voltage non-linear resistor ceramic, comprising:
main phase grains having zinc oxide as a main component,
wherein at least one of the main phase grains comprise an intragranular segregation phase, and
the intragranular segregation phase includes an oxide including Sn.

2. The voltage non-linear resistor ceramic according to claim 1, wherein the intragranular segregation phase comprises zinc oxide and tin oxide, and a weight ratio of tin oxide with respect to zinc oxide in terms of ZnO and SnO₂ is 0.9% or greater to 3.1% or less.

3. The voltage non-linear resistor ceramic according to claim 1, wherein a ratio of a cross-section area of the intragranular segregation phase with respect to a cross-section area of at least one of the main phase grains including the intragranular segregation phase is 0.07% or greater to 18% or less.

4. The voltage non-linear resistor ceramic according to claim 1, wherein a ratio of a shortest distance between an outer circumference of the cross section of at least one of the main phase grains including the segregation phase and an outer circumference of a cross section of the intragranular segregation phase with respect to a grain size of a cross section of at least one of the main phase grains including the intragranular segregation phase is 3.0% or greater to 49% or less.

5. The voltage non-linear resistor ceramic according to claim 1, wherein the intragranular segregation phase comprises one or more selected from the group consisting of cobalt oxide, chromium oxide, silicon oxide, silver oxide, bismuth oxide, and praseodymium oxide.

6. The voltage non-linear resistor ceramic according to claim 5, wherein the intragranular segregation phase comprises bismuth oxide and/or praseodymium oxide.

7. The voltage non-linear resistor ceramic according to claim 5, wherein the intragranular segregation phase comprises silver oxide.

8. An electronic device comprising the voltage non-linear resistor ceramic according to claim 1.
